(19) United States
(12) Patent Application Publication
(10) Pub. No.: US 2024/0398151 A1
(43) Pub. Date: Dec. 5, 2024

(54) MACHINE AND METHOD FOR PREPARING BEVERAGES BASED ON COFFEE BEANS

(71) Applicant: DE' LONGHI APPLIANCES S.R.L. CONUNICO SOCIO, TREVISO (IT)

(72) Inventors: Antonio Panciera, Treviso (IT); Igor Trevisan, Treviso (IT); Stefano Salvadori, Treviso (IT); Simone Rosetta, Treviso (IT)

(73) Assignee: DE' LONGHI APPLIANCES S.R.L. CONUNICO SOCIO, TREVISO (IT)

(21) Appl. No.: 18/694,409

(22) PCT Filed: Sep. 20, 2022
(86) PCT No.: PCT/IT2022/050253

§ 371 Date: Mar. 21, 2024

(30) Foreign Application Priority Data
Sep. 21, 2021 (IT) 102021000024248

(51) Int. Cl. A47J 31/42; A47J 31/50; A47J 31/52

(52) U.S. Cl. CPC A47J 31/42; A47J 31/50; A47J 31/5251; A47J 31/5253; A47J 31/5255

(57) ABSTRACT

A machine for preparing coffee-based beverages starting from whole coffee beans includes a hopper configured to contain the coffee beans, a grinding member associated with said hopper to grind the coffee beans in order to obtain a coffee powder, brewing means configured to subject the coffee powder to brewing, hydraulic means configured to supply water to the brewing means, and identification means configured to automatically identify one or more actual characteristics of the coffee beans and to automatically associate with the one or more actual characteristics one or more functioning parameters for at least one of either the grinding member, the brewing means or the hydraulic means.

### FIELD OF THE INVENTION

The present invention concerns a machine and a method for preparing coffee-based beverages, preferably espresso coffee, starting from whole coffee beans.

### BACKGROUND OF THE INVENTION

Machines for preparing coffee-based beverages are known, starting from whole coffee beans, which comprise a hopper in which the whole coffee beans are disposed, a grinding device to grind them in order to produce a coffee powder, and a brewing unit, fed by a hydraulic circuit, which receives the coffee powder and brews it to produce the coffee-based beverage.

It is also known that in order to prepare a coffee-based beverage by brewing, it is necessary to set and control a plurality of functioning parameters of the machine, such as, for example but not only, the pressure of the brewing chamber, the temperature and the quantity of the brewing water, the granulometry and the quantity of coffee powder used for each beverage, and others.

Usually, these functioning parameters vary according to the type, variety and characteristics of the coffee beans used to prepare the coffee powder to be infused. The most common types of coffee are, for example, Coffea Arabica, Coffea Robusta, or Canephora, Coffea Liberica and Coffea Excelsa.

In this context, machines for producing coffee-based beverages are known, which allow to modify at least some of these functioning parameters, by acting, mostly manually, on the settings of some components, such as, for example, the brewing unit, the grinding device, the dosing unit and others.

However, to adjust and set the functioning parameters of the machine in order to obtain a “good” coffee-based beverage, a certain experience and knowledge of the correlation between the actual characteristics of the coffee beans, the functioning parameters of the machine and the final characteristics of the coffee-based beverage is required.

Usually, the average consumer does not have the experience required to adjust these parameters manually, and therefore he/she would have to try to modify them in an approximate manner, or by trial and error, until a satisfactory result is obtained, but without being sure of having reached the optimal setting of the machine in objective terms.

Furthermore, since these functioning parameters are correlated to the varieties of coffee beans used, each time a new variety or a new blend of varieties of coffee beans is used, it is necessary to adjust the functioning parameters again.

All this could also lead to dissatisfaction on the part of the consumer, who is required to perform burdensome operations to set up the machine correctly, and also to a negative judgment on the functioning of the machine, if the coffee obtained does not satisfy the consumer's tastes.

There are also machines for preparing coffee-based beverages which comprise means to recognize the information printed on the commercial package containing the coffee beans, such as, for example, bar codes, QR codes, RFIDs and others. By means of these recognition means, the machine can recognize the varieties of coffee beans contained in the package and consequently optimize its functioning parameters.

However, these solutions are limited to reading the information contained on the packages of coffee beans, although not all coffee packages contain all the necessary information.

In fact, there are still many roasting companies, even small ones, that put blends on the market consisting of different varieties of coffee, without reporting on the package, in a machine-readable way, the relevant information on the composition of the blend it contains.

Furthermore, this solution requires the user to read the information contained on the package of coffee beans, using the recognition devices, at least every time he/she changes the variety or blend of coffee beans.

Document DE102019200788 describes a fully automatic coffee machine equipped with a device for setting at least one delivery parameter and a sensor device designed to record at least one parameter of the coffee bean and connected to the setting device, which adjusts the delivery parameter according to the parameter detected by the sensor device. The sensor device comprises a camera by means of which, based on the detection of the color of the beans, which is compared with a characteristic table, their level of roasting is determined, or an optical sensor by means of which it is possible to read a bar code or two-dimensional code on a package of coffee beans.

U.S. Pat. No. 8,944,354B2 describes a machine for preparing coffee comprising a plurality of containers, each suitable to contain one type of coffee beans, and each selectively connectable to the machine. Each container can comprise information regarding the type of coffee beans contained in it and the machine can comprise an identification component of an optical type by means of which it is possible to receive information regarding the type of coffee beans and adapt the functioning of the machine based on the type of beans associated with the container identified.

There is therefore a need to perfect a machine and a method for preparing coffee-based beverages which can overcome at least one of the disadvantages of the state of the art. All of this by solving the technical problem of ensuring that the machine does not need information coming from outside, or provided by a consumer, but that it can acquire such information autonomously, in order to define the optimal functioning parameters.

In particular, one purpose of the present invention is to provide a machine for preparing coffee-based beverages, starting from coffee beans, which allows even an inexperienced user to obtain an excellent coffee-based beverage, in objective terms, without requiring intervention by the user to set the functioning parameters of the machine.

Another purpose of the present invention is to provide a machine for preparing coffee-based beverages which is able to automatically adjust and optimize its functioning parameters based on the actual coffee beans used to prepare the coffee-based beverage.

Another purpose of the present invention is to provide a machine for preparing beverages which does not require the use of specific containers or packages for the coffee beans which comprise suitable bar codes, nor does it require to create a correlation between a container and the coffee beans contained in it.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes and to resolve the above technical problem in a new and original way, also obtaining considerable advantages compared to the state of the prior art, a machine according to the present invention for preparing coffee-based beverages starting from coffee beans comprises a hopper configured to contain the coffee beans, a grinding member associated with the hopper to grind the coffee beans and obtain a coffee powder, brewing means configured to subject the coffee powder to brewing, and hydraulic means configured to supply water to the brewing means.

In accordance with one aspect of the present invention, the machine also comprises identification means configured to automatically identify one or more actual characteristics of the coffee beans and to automatically associate with the one or more actual characteristics one or more optimal functioning parameters for at least one of either the grinding member, the brewing means or the hydraulic means.

This achieves at least the advantage of setting the functioning parameters of the machine automatically, without the use of external means and without user intervention, on the basis of the actual characteristics of the coffee beans used.

In accordance with another aspect of the present invention, the one or more actual characteristics comprise at least one characteristic selected from a group comprising the different varieties of the beans, the presence percentage of each of such varieties, the roasting level of the beans and the surface oiliness thereof.

According to some embodiments, the actual characteristics as above comprise at least the variety of coffee beans.

In accordance with another aspect of the present invention, the identification means comprise at least one image acquisition device configured to acquire at least one image of the coffee beans contained in the hopper.

The image acquisition device can be disposed in proximity to, or inside, the hopper.

Preferably, the image acquisition device is configured to acquire a series of images of the coffee beans in succession.

In accordance with another aspect of the present invention, the identification means also comprise a lighting device configured to selectively illuminate the inside of the hopper.

In accordance with another aspect of the invention, the identification means are configured to selectively emit light beams that have at least two different wavelengths.

Preferably, the lighting device comprises at least two lighting elements configured to emit respective light beams that have different wavelengths from each other, and the image acquisition device is configured to acquire a sequence of images of the beans illuminated with different wavelengths.

The acquisition of at least two images of the beans illuminated with at least two different wavelengths allows to obtain more, as well as more precise, information on the type of coffee beans. In particular, on the basis of the processing and comparison of the images acquired, it is possible to achieve one or more of the following advantages:
recognize the shape of the coffee beans so as to identify their variety/type;
recognize the color shades with greater precision in order to identify their roasting level or surface oiliness level.

In accordance with another aspect of the present invention, the identification means also comprise a processing unit comprising analysis means which are configured to analyze at least one of either the shape, sizes or color of the coffee beans represented in the image, or series of images, and consequently assign the one or more actual characteristics thereto.

According to another aspect of the invention, the analysis means are configured to analyze the shape, sizes and color of the coffee beans represented in the image, or series of images, and consequently assign the one or more actual characteristics thereto.

In accordance with another aspect of the present invention, the processing unit also comprises comparison means configured to compare the one or more actual characteristics with one or more combinations of predetermined characteristics stored in a memory of the processing unit, each of which is associated with a corresponding combination of predetermined functioning parameters, which are also stored in the memory of the processing unit, and then to associate with the one or more actual characteristics a determinate combination of predetermined functioning parameters corresponding to the combination of predetermined characteristics most similar to the one or more actual characteristics.

In accordance with another aspect of the present invention, the processing unit also comprises assigning means for assigning determinate numerical values to the one or more actual characteristics, and processing means that process, according to one or more correlation equations stored in a memory of the processing unit, the numerical values in order to obtain the one or more functioning parameters.

In accordance with another aspect of the present invention, the machine also comprises a command unit configured to command and adjust the functioning of at least one of either the hopper, the grinding member, the hydraulic means or the brewing means. Furthermore, the processing unit is configured to transmit the one or more functioning parameters to the command unit in order to control and adjust the functioning of at least one of either the hopper, the grinding member, the hydraulic means or the brewing means.

In accordance with another aspect of the present invention, the one or more functioning parameters comprise at least one parameter selected from a group comprising the temperature of the brewing water, the brewing time, the flow rate of the brewing water, the quantity of brewing water, the brewing pressure, the quantity of coffee-based beverage to be prepared, the pre-brewing parameters comprising the temperature, the quantity of pre-brewing water, the pre-brewing time, the beverage delivery time, the speed and flow rate of the brewing water, the granulometry/grinding level of the coffee powder and the quantity of the latter to be subjected to brewing.

The present invention also concerns a method for preparing coffee-based beverages starting from coffee beans by means of a machine that has a hopper configured to contain the coffee beans, a grinding member associated with the hopper to grind the coffee beans in order to obtain a coffee powder, brewing means configured to subject the coffee powder to brewing, and hydraulic means configured to supply water to the brewing means.

In accordance with another aspect of the present invention, the method comprises an identification step in which one or more actual characteristics of the coffee beans are automatically identified by means of identification means, and one or more functioning parameters for at least one of either the grinding member, the brewing means or the hydraulic means are automatically associated with the one or more actual characteristics.

In accordance with another aspect of the present invention, the identification step provides to:
acquire at least two images of the coffee beans illuminated on each occasion by one of at least two lighting elements configured to emit respective light beams that have different wavelengths from each other;
process the images to identify the one or more actual characteristics.

According to another aspect of the invention, the identification step provides to analyze at least one of either the shape, sizes or color of the coffee beans represented in the image in order to assign to the image the one or more actual characteristics as above, selected from a group comprising the different varieties of the beans, the presence percentage of each of the varieties, the roasting level of the beans and the surface oiliness thereof.

In accordance with another aspect of the present invention, in order to assign the one or more actual characteristics to the image, the identification step provides to analyze the shape, sizes and color of the coffee beans represented in the image.

In accordance with another aspect of the present invention, the identification step also provides to compare the one or more actual characteristics with one or more combinations of predetermined characteristics stored in a memory of a processing unit, each of which is associated with a corresponding combination of predetermined functioning parameters stored in such memory of such processing unit and then to associate with the one or more actual characteristics a determinate combination of predetermined functioning parameters corresponding to the combination of predetermined characteristics most similar to the one or more actual characteristics as above.

In accordance with another aspect of the present invention, the identification step also provides to assign determinate numerical values to the one or more actual characteristics and to process such numerical values in order to obtain the one or more functioning parameters.

In accordance with another aspect of the present invention, the method also comprises an adjustment step in which the functioning parameters of the machine are adjusted on the basis of the one or more functioning parameters as above.

### DESCRIPTION OF THE DRAWINGS

These and other aspects, characteristics and advantages of the present invention will become apparent from the following description of some embodiments, given as a non-restrictive example with reference to the attached drawings wherein:

FIGS. 1, 2 and 3 are diagrams of three different embodiments of a machine for preparing beverages based on coffee beans, in accordance with the present invention;

FIG. 4 is a schematic section view of a part of a machine for preparing beverages based on coffee beans, in accordance with one embodiment of the present invention;

FIGS. 5, 6 and 7 are schematic views of three embodiments of a part of a machine for preparing beverages based on coffee beans in accordance with the present invention;

FIGS. 8, 9 and 10 schematically show the shape of three different varieties of coffee beans.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

With reference to FIGS. 1, 2 and 3, a machine for preparing coffee-based beverages, hereafter machine 10, according to the present invention, is suitable to prepare a coffee-based beverage starting from coffee beans, preferably whole ones, denoted by C1, C2, C3.

The coffee beans C1, C2, C3 can come from different types such as, for example, Coffea Arabica (FIG. 8), Coffea Robusta, or Canephora, (FIG. 9) and Coffea Liberica (FIG. 10). Each type of coffee beans can in turn comprise a plurality of varieties, for example depending on the geographical area of origin or the cultivation altitude.

The machine 10 comprises a rest base 11 on which there is mounted a frame 12 shaped in such a way as to define a compartment 13 in which a brewing unit 15 is housed comprising a brewing chamber 16 configured to contain a determinate quantity of coffee powder P to be subjected to brewing, in order to obtain the coffee-based beverage.

Furthermore, the compartment 13 houses both a hydraulic circuit 17, comprising, for example, a tank 17a, a flow meter 17b, a pump 17c, pipes 17d and a boiler 17e, to feed water to the brewing unit 15, and also a delivery unit 19, fluidically connected to the brewing unit 15 in order to deliver the coffee-based beverage into a container 20, for example a cup, a mug, or suchlike.

The machine 10 also comprises a grinding unit 21 and a hopper 22 which is suitable to contain the coffee beans C1, C2, C3.

The hopper 22 comprises a plurality of lateral walls 23 and a closing lid 25 which define between them a containing compartment 26 in which the coffee beans C1, C2, C3 can be disposed.

The grinding unit 21 also comprises a grinding member 29 configured to grind a quantity of coffee beans C1, C2, C3 according to a precise granulometry so as to obtain the coffee powder P to be subjected to brewing.

The grinding unit 21 can also be provided with a dosing device 27 for dosing the right quantity of coffee beans C1, C2, C3 to be ground.

According to possible variants, a dosing device suitable to dose a quantity of powder to be supplied to the brewing chamber 16 can also be provided.

The brewing unit 15, the hydraulic circuit 17, the delivery unit 19 and the dosing device 27 can be of any known type that allows to adjust the respective functioning parameters S1, . . . , Sn and, therefore, will not be described in detail.

For example, the above functioning parameters S1, . . . , Sn can comprise the temperature of the brewing water, the brewing time, the flow rate of the brewing water, the quantity of brewing water, the brewing pressure, the quantity of coffee beverage to be prepared, the temperature and quantity of the pre-brewing water, the quantity of coffee to be ground, the pre-brewing time, the beverage delivery time, the speed/flow rate of the brewing water, or others.

The operation of the brewing unit 15, of the hydraulic circuit 17, of the delivery unit 19 and of the grinding unit 21, to which we will refer hereafter with the term “operating components”, is commanded and adjusted by a command unit 30, for example of the programmable type.

According to one aspect of the invention, the machine 10 comprises identification means 24 configured to automatically identify one or more actual characteristics F of the coffee beans C1, C2, C3 and to automatically associate with the one or more actual characteristics F one or more functioning parameters S for at least one of either the grinding member 29, the brewing unit 15 or the hydraulic circuit 17.

According to one aspect of the present invention, the identification means 24 comprise a detection member 31 associated with the hopper 22 and configured to obtain at least one image I of the coffee beans C1, C2, C3 contained in the containing compartment 26 and to transmit the image I to the command unit 30 or to a processing unit 41, as will be described below.

The detection member 31 comprises an image acquisition device 32 and a lighting device 33 which are facing toward the inside of the containing compartment 26.

According to some embodiments, at least the image acquisition device 32 and the lighting device 33 are integrated in the closing lid 25.

According to other embodiments, the image acquisition device 32 and/or the lighting device 33 can be connected to the closing lid 25 or possibly also to a top portion of a lateral wall of the hopper 22.

The image acquisition device 32 comprises a photo camera 35 with, for example, a resolution comprised between about 1 Mpx and about 16 Mpx, and the lighting device 33 comprises a plurality of lighting elements 36, 37, 38, 39, for example LED diodes, disposed in proximity to the photo camera 35.

In a preferred embodiment, the lighting device 33 comprises at least two lighting elements 36, 37, 38, 39 that have a different wavelength from each other.

Furthermore, preferably, the detection member 31 is configured to obtain a series, that is, a sequence, of images of the coffee beans C1, C2, C3 in which at least two images of such sequence are acquired when the coffee beans C1, C2, C3 are illuminated with two different wavelengths. We must clarify that hereafter in the description the term “at least one image” can mean either a single image or a sequence of images.

The command unit 30 can in particular be configured to command the lighting device 33 in such a way that it illuminates the coffee beans C1, C2, C3 alternately with the at least two different wavelengths, and to command the image acquisition device 32 in such a way that it acquires at least one image I for each wavelength.

According to some embodiments, the acquired images of one series, or sequence, are framed in substantially the same way.

According to possible variants, the acquired images of one series, or sequence, are framed differently, for example by suitably adjusting the image acquisition device 32.

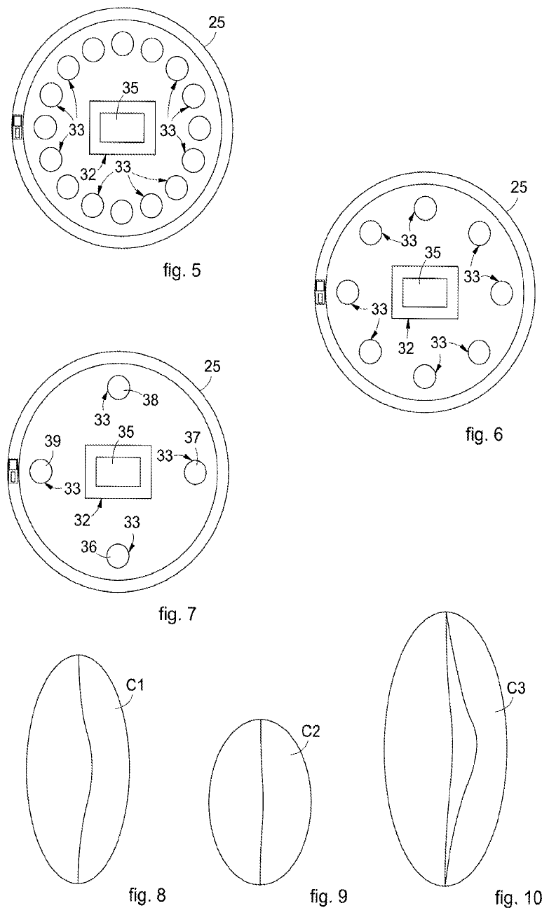

In the embodiment shown in FIG. 7, the lighting device 33 comprises four lighting elements 36, 37, 38, 39. For example, there can be provided a first lighting element 36 that has a wavelength comprised between about 400 nm and about 450 nm, a second lighting element 37 that has a wavelength comprised between about 450 nm and about 500 nm, a third lighting element 38 that has a wavelength comprised between about 500 nm and about 550 nm and a fourth lighting element 39 that has a wavelength comprised between about 550 nm and about 700 nm.

Preferably, the photo camera 35 is disposed in a central zone and the lighting elements 36, 37, 38, 39 are disposed around it.

Alternatively, in the embodiment shown in FIG. 6 the lighting device 33 comprises eight lighting elements, or in the embodiment shown in FIG. 5 the lighting device 33 comprises sixteen lighting elements, each of which can have its own wavelength, or which can be divided into groups in which the lighting elements have the same wavelength.

It is clear that the number of lighting elements and the total number of wavelengths of the beams emitted by each of them can also be different, for example a number comprised between 2 and 20.

Advantageously, the difference in wavelengths between each lighting element 36, 37, 38, 39 promotes the acquisition of an image I optimized for its processing, which will be described below. The optimized image I allows, in particular, to distinguish the shape and color of coffee beans C1, C2, C3 and consequently recognize one or more actual characteristics of the coffee beans C1, C2, C3, in particular at least their type and/or variety.

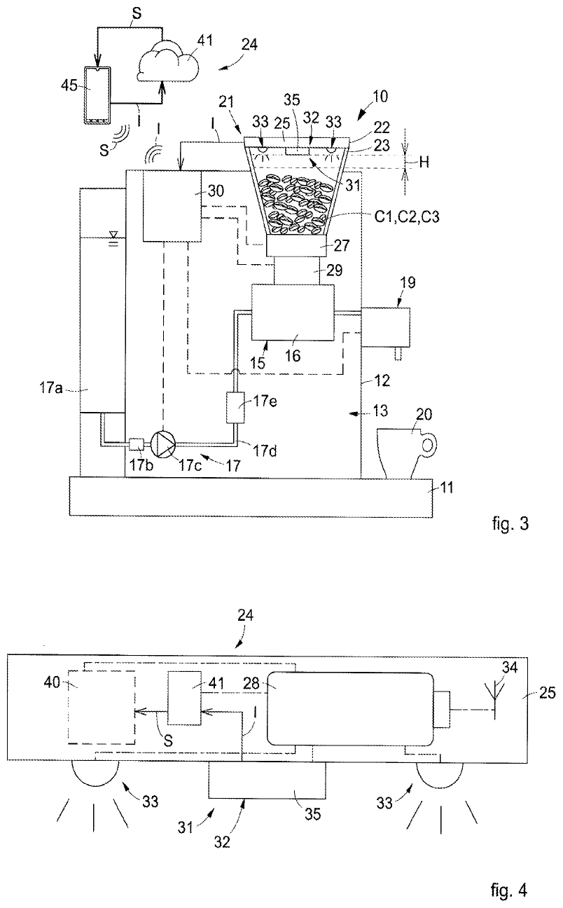

Furthermore, the lighting device 33 and/or the image acquisition device 32 are preferably disposed at a determinate minimum distance H from the maximum level of the coffee beans C1, C2, C3 contained in the containing compartment 26, which is advantageously within in a range comprised between about 1 cm and about 2 cm (FIG. 3).

The overall distance between the lighting device 33 and/or the image acquisition device 32 and the coffee beans C1, C2, C3 can vary between the minimum distance H and about 20 cm, as a function of the filling level of the hopper 22 and of its overall height.

Optionally, the detection member 31 can also be configured to detect the level of the coffee beans C1, C2, C3 in the hopper 22 and to signal this information to the command unit 30.

In some embodiments, the command unit 30 can also be configured to adjust the settings of the photo camera 35 as a function of the level of coffee beans C1, C2, C3 detected and therefore of the distance with respect thereto.

By way of example, settings of the photo camera 35 can comprise: shutter aperture, possible focus function, definition, or more.

Furthermore, when the level of the coffee beans C1, C2, C3 reaches a determinate minimum value, the command unit 30 can communicate to a user the need for refilling, for example by means of warning lights or messages displayed on an interface (not shown).

In other embodiments, not shown in the drawings, the detection member 31 is integrated into a lateral wall 23 of the hopper 22 which, in these other embodiments, can be without the closing lid 25.

The command unit 30 is also configured to transmit the at least one image I to a processing unit 41 configured to process the image I in order to obtain one or more functioning parameters S1, . . . , Sn, collectively indicated as set of optimal functioning parameters S, of the operating components of the machine 10. In particular, the processing unit 41 is configured to receive and process a series of at least two images of the coffee beans, respectively acquired with a light that has different wavelengths.

Furthermore, the processing unit 41 is configured to transmit the set of optimal functioning parameters S to the command unit 30, which can automatically set the operation of the operating components of the machine 10 on the basis of the set of optimal functioning parameters S.

This allows to automatically set, without the use of external means and also without the intervention of the user, the functioning parameters of the operating components of the machine 10 as a function of the actual characteristics of the coffee beans C1, C2, C3 used, in order to prepare an excellent coffee base, in objective terms.

In accordance with some embodiments of the present invention, the processing unit 41 is physically present in the machine 10 (FIG. 1 or 4) and comprises a processor of any known type whatsoever and a memory unit. For example, in a first embodiment the processing unit 41 is disposed inside the compartment 13, together with the command unit 30.

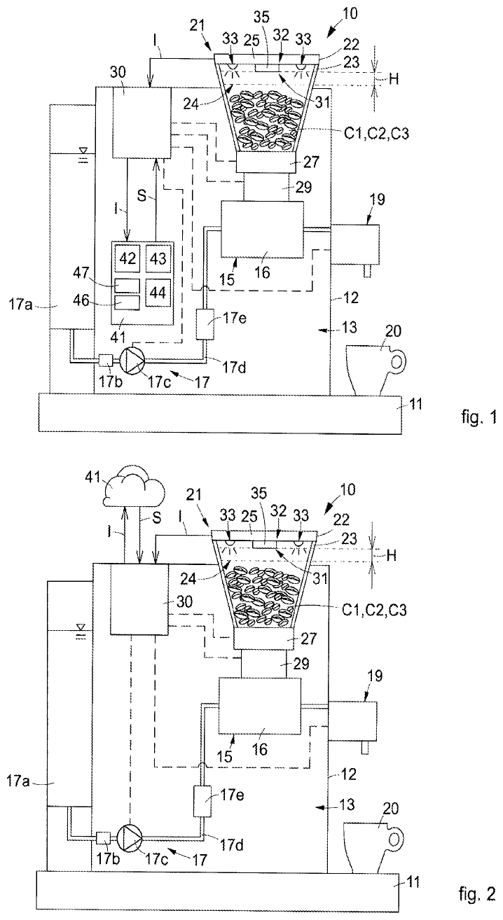

In another embodiment, the processing unit 41 is located on a so-called “Cloud” platform (FIG. 2). In this other embodiment, the command unit 30 is of the type that can be connected, preferably in wireless mode, to the Internet, for access to the “Cloud” platform.

According to one embodiment, described with reference to FIG. 4, the lid 25 can be of the type that can be removed and separated from the hopper 22.

According to this embodiment, it can be provided that on the lid 25, together with the detection member 31 and the lighting device 33, there is also installed a battery 28, of the replaceable or rechargeable type, suitable to supply electrical power to the various components and allow the acquisition of images even when the lid 25 is not associated with a hopper 22. In this case, it can be provided that a user acquires an image I of the beans to be used in a separate position from the machine 10.

According to some embodiments, the processing unit 41 can be integrated in the lid 25 to receive and analyze the image I acquired by the photo camera 35 and to supply the set of optimal functioning parameters S to the command unit 30, for example by means of an antenna 34 or other wireless communication device.

An auxiliary control unit 40 can also be provided on the lid 25, which can communicate with the command unit 30 and/or with a processing unit 41 located on the “Cloud” platform. In this case, the auxiliary control unit 40 can be configured to command the functioning of the image acquisition device 32 and of the lighting device 33.

Alternatively, or in addition, the command unit 30 is of the type that can be connected, preferably in wireless and short-range mode, to an external electronic device 45 (FIG. 3), such as a user's smartphone, which can, in turn, be connected to the Internet to access the “Cloud” platform, where the processing unit 41 can be located.

The processing unit 41 comprises a memory 47 in which algorithms for analyzing the coffee beans C1, C2, C3, shown in the at least one image I, are stored in order to assign to the coffee beans C1, C2, C3 one or more actual characteristics F1, . . . , Fn, collectively referred to as set of actual characteristics F.

The processing unit 41 can be configured to analyze at least one of either the shape, sizes or color of the coffee beans C1, C2, C3 present in image I in order to assign one or more actual characteristics F1, . . . , Fn.

The actual characteristics F1, . . . , Fn identified by the analysis algorithms can comprise at least one of either the types and/or varieties of the coffee beans C1, C2, C3, the presence percentage of each type/variety, the roasting level of the coffee beans C1, C2, C3, the level of surface oiliness thereof or the process used to process and extract them, normally identified with the terms “Washed” or “Natural”, also called dry.

Furthermore, algorithms for analyzing the coffee beans C1, C2, C3 can also recognize the presence of defective coffee beans, the presence of objects or substances that cannot be identified as coffee beans, or the presence of coffee beans unsuitable for grinding and preparing coffee such as, for example, beans with a roasting color that is too light, such as the so-called “green” coffee not yet roasted, or roasted barley seeds.

The identification algorithms are based on artificial intelligence, and preferably comprise a neural network.

In particular, for image recognition, the processing unit 41 can comprise analysis algorithms based on the state of the art of deep convolutional neural networks designed for image classification, such as EfficientNet, MobileNet, ResNet or VGG16. This allows to identify, on each occasion, the most suitable network architecture according to accuracy and computational cost requirements. Using the networks mentioned here also allows to take advantage of the use of pre-trained networks to apply “Transfer Learning” techniques, and therefore reduce the size of the data set required for their training.

Furthermore, association algorithms are stored in the memory of the processing unit 41 to associate the set of actual characteristics F of the coffee beans C1, C2, C3 to a set of optimal functioning parameters S for the operating components of the machine 10.

The set of optimal functioning parameters S comprises one or more values that refer to at least one of either the following parameters S1, . . . , Sn: the temperature of the brewing water, the brewing time, the flow rate of the brewing water, the quantity of brewing water, the brewing pressure, the quantity of coffee beverage to be prepared, the temperature and quantity of the pre-brewing water, the pre-brewing time and also the beverage delivery time, the granulometry and the grinding level of the coffee powder and the quantity thereof to be subjected to brewing.

In one embodiment, a plurality of combinations of predetermined functioning parameters SM are stored in the memory of the processing unit 41, each of which is associated with a combination of predetermined characteristics FM of coffee beans. In this embodiment, the processing unit 41 is configured to compare the set of actual characteristics F with the combinations of predetermined characteristics FM. Furthermore, the processing unit 41 is also configured to associate with the one or more actual characteristics F the combination of predetermined functioning parameters SM corresponding to the combination of predetermined characteristics FM most similar to the set of actual characteristics F.

In another embodiment, in the memory of the processing unit 41 there are stored one or more equations of correlation between the characteristics F1, . . . , Fn of the coffee beans C1, C2, C3 and the values of the functioning parameters S1, . . . , Sn, the set of optimal functioning parameters S being determined by such equations. In particular, in this other embodiment, the processing unit 41 is configured to assign determinate numerical values N1, . . . , Nn to one or more actual characteristics F1, . . . , Fn and to process such values in order to obtain the set of optimal functioning parameters S.

According to some embodiments, the processing unit 41 is configured to classify the images I received in order to identify actual characteristics F, at least the type and/or variety of the photographed coffee beans C1, C2, C3.

Based on the shape and color of the coffee beans C1, C2, C3 present in the images I, it is also possible to determine whether they belong to a same type/variety or whether they belong to different type/varieties, and possibly estimate their respective percentages. The optimal functioning parameters S are therefore determined at least as a function of the type/variety of the coffee beans C1, C2, C3.

The processing unit 41 can comprise analysis means 42 configured to analyze at least one of either the shape, sizes or color of the coffee beans represented in the image, or series of images, and consequently assign the one or more actual characteristics to the coffee beans.

According to other embodiments, the analysis means 42 are configured to analyze at least one of either the shape, sizes or color of the coffee beans represented in the image, or series of images, and consequently assign the one or more actual characteristics to the coffee beans.

The processing unit can also comprise comparison means 43 configured to compare the one or more actual characteristics F with the combinations of predetermined characteristics FM.

The processing unit 41 can also comprise assigning means 44 for assigning the numerical values N1, . . . , Nn to the actual characteristics F and processing means 46 that processes, according to one or more correlation equations stored in the memory 47, the numerical values in order to obtain the several functioning parameters S.

The analysis 42, comparison 43, assigning 44 and processing 46 means can be defined by respective electrical/electronic components of a CPU or of a neural network.

The operation of the machine 10 for preparing beverages based on coffee beans described heretofore, which corresponds to the method according to the present invention, comprises the following steps.

A user disposes in the containing compartment 26 of the hopper 22 a plurality of coffee beans C1, C2, C3, preferably whole ones, with which he/she wishes to prepare a beverage based on coffee beans.

The detection member 31 detects the presence of the coffee beans C1, C2, C3 in the housing compartment 26 and automatically acquires, by means of the photo camera 35, at least one image I of the beans C1, C2, C3 present in the housing compartment 26.

During the acquisition of the at least one image I, the lighting device 33 illuminates the inside of the housing compartment 26 by means of at least two lighting elements 36, 37, 38, 39 each having a determinate wavelength.

In a preferred embodiment, the detection member 31 acquires, by means of the photo camera 35, a sequence of images I of the beans C1, C2, C3 present in the housing compartment 26. For example, the detection member 31 acquires both at least a first image of the beans C1, C2, C3 present in the housing compartment 26 when a first lighting element 36 illuminates them with a first wavelength, and also at least a second image of the beans C1, C2, C3 present in the housing compartment 26 when a second lighting element 37 illuminates them with a second wavelength, different from the first wavelength.

The acquisition of a sequence of images I of the beans C1, C2, C3 illuminated with different wavelengths allows the analysis algorithms to determine the characteristics F1, . . . , Fn in a faster and more efficient way, from a computational point of view.

Furthermore, in this way it is possible to obtain a plurality of different images, each suitable to provide determinate information that can help define the actual characteristics of the coffee beans C1, C2, C3 photographed.

The detection member 31 transmits the at least one image I to the command unit 30 which, in turn, transmits it to the processing unit 41.

If the processing unit 41 is integrated in the machine 10, this transmission occurs via cable (FIG. 1).

If the processing unit 41 is located in a “Cloud” platform and the command unit 30 is of the type that can be connected to the Internet, the transmission of the at least one image I occurs via the Internet (FIG. 2). Alternatively, if the command unit 30 is of the type that can be connected to external electronic devices 45 wirelessly and short-range, the former transmits the at least one image I to an external electronic device 45, which in turn transmits it, via the Internet, to the processing unit 41 located in the “Cloud” platform (FIG. 3).

The analysis algorithms, stored in the processing unit 41, analyze the shape and sizes of the coffee beans C1, C2, C3 represented in the at least one image I in order to determine the type and varieties thereof, and also the presence percentage of the varieties identified.

In fact, it is known that the different varieties of coffee beans C1, C2, C3 have different shapes and sizes; for example, FIG. 6 schematically shows a bean C1 of the “Arabica” type, FIG. 7 shows a bean C2 of the “Robusta” type, and FIG. 8 schematically shows a bean C3 of the “Liberica” type. It is also known that the beans of a same type can be different depending on the variety, for example, depending on the geographical origin and/or the cultivation altitude. For example, the beans of the “Maragogype” variety belonging to the “Arabica” type usually have a length of more than 10 mm, or the beans of the “Peaberry” variety of the “Robusta” type usually have a length of less than 5 mm.

The analysis algorithms can also analyze the color of the coffee beans C1, C2, C3 in order to obtain a plurality of information.

In particular, the analysis algorithms analyze the color of the coffee beans C1, C2, C3 represented in the at least one image I to determine the roasting level thereof in order to assign a roasting level to them, such as, for example, “light”, “medium”, “dark”, “extra-dark”.

In addition, or alternatively, the analysis algorithms analyze the color of the coffee beans C1, C2, C3 represented in the at least one image I also to determine the level of surface oiliness thereof in order to assign an oiliness level to them, such as, for example, “absent”, “medium” or “high”.

Furthermore, the analysis algorithms analyze the color of the coffee beans C1, C2, C3, to identify the process used to process and extract the beans, assigning a characteristic to them, such as, for example, “natural” or “washed”.

Advantageously, the illumination of the beans C1, C2, C3 by means of a plurality of lighting elements 36, 37, 38, 39 that have different wavelengths from each other facilitates the analysis of the color of the image I and, therefore, the determination of the roasting level and surface oiliness level of the beans C1, C2, C3 represented in the image I.

We must clarify that each variety identified can be assigned a corresponding roasting level and a corresponding surface oiliness level.

At the end of the analysis of the at least one image I, the analysis algorithms provide the set of actual characteristics F of the coffee beans C1, C2, C3.

For example, a set of actual characteristics F can be: F=(blend=40% Arabica and 60% Robusta; Arabica portion roasting level=medium; Robusta portion roasting level=extra-dark; Arabica portion surface oiliness=absent; Robusta portion surface oiliness=high).

The set of actual characteristics F of the coffee beans C1, C2, C3 is used as a starting data set to associate the set of optimal functioning parameters S with the coffee beans C1, C2, C3.

In one embodiment, the processing unit 41 compares the set of actual characteristics F with a plurality of combinations of predetermined characteristics FM. A combination of predetermined functioning parameters SM is assigned to each combination of predetermined characteristics FM. In this embodiment, the processing unit 41 associates with the set of actual characteristics F the combination of predetermined functioning parameters SM corresponding to the combination of predetermined characteristics FM most similar to the set of actual characteristics F.

In another embodiment, the processing unit 41 associates with each actual characteristic F1, . . . , Fn present in the set of actual characteristics F a determinate numerical value N1, . . . , Nn which is processed by means of one or more predetermined correlation equations in order to obtain the values S1, . . . , Sn of the functioning parameters of the set of optimal functioning parameters S.

When the set of optimal functioning parameters S has been determined, the processing unit 41 transmits it to the command unit 30 which, on the basis thereof, automatically adjusts the operation of the operating components of the machine 10.

It is clear that modifications and/or additions of parts may be made to the machine 10 and to the method for preparing coffee-based beverages as described heretofore, without departing from the field and scope of the present invention, as defined by the claims.

It is also clear that, although the present invention has been described with reference to some specific examples, a person of skill in the art shall certainly be able to achieve many other equivalent forms of machine and method for preparing coffee-based beverages, having the characteristics as set forth in the claims and hence all coming within the field of protection defined thereby.

In the following claims, the sole purpose of the references in brackets is to facilitate reading and they must not be considered as restrictive factors with regard to the field of protection defined by the same claims.

1. A machine for preparing coffee-based beverages starting from coffee beans comprising; a hopper configured to contain said coffee beans, a grinding member associated with said hopper to grind said coffee beans and obtain a coffee powder, brewing means configured to subject said coffee powder to brewing, hydraulic means configured to supply water to said brewing means, and further including identification means configured to automatically identify one or more actual characteristics of said coffee beans and to automatically associate with said one or more actual characteristics one or more functioning parameters for at least one of either said grinding member, said brewing means or said hydraulic means, and wherein said identification means comprise at least one lighting device which is configured to illuminate the inside of said hopper and has at least two lighting elements which are configured to emit respective light beams that have a different wavelength with respect to each other, and an image acquisition device configured to acquire at least two images of said beans illuminated on each occasion by one of said at least two lighting elements.

2. The machine for preparing coffee-based beverages as in claim 1, wherein said image acquisition device and said lighting device are disposed, during use, inside said hopper.

3. The machine for preparing coffee-based beverages as in claim 1, in which said hopper comprises a removable lid, wherein at least one of either said image acquisition device or said lighting device is installed on said lid and is powered by means of battery power supply means which are also disposed on said lid.

4. The machine for preparing coffee-based beverages as in claim 1, wherein said image acquisition device and said lighting device are both integrated in a closing lid of said hopper.

5. The machine for preparing coffee-based beverages as in claim 1, wherein said identification means also comprise a processing unit comprising analysis means configured to analyze at least the shape, sizes and color of the coffee beans represented in said image and consequently assign said one or more actual characteristics thereto.

6. The machine for preparing coffee-based beverages as in claim 5, wherein said processing unit also comprises comparison means configured to compare said one or more actual characteristics with one or more combinations of predetermined characteristics stored in a memory of said processing unit, each of which is associated with a corresponding combination of predetermined functioning parameters stored in said memory of said processing unit, and then to associate with said one or more actual characteristics a determinate combination of predetermined functioning parameters corresponding to the combination of predetermined characteristics most similar to said one or more actual characteristics.

7. The machine for preparing coffee-based beverages as in claim 5, wherein said processing unit also comprises assigning means for assigning determinate numerical values to said one or more actual characteristics, and processing means that process said numerical values to obtain said one or more functioning parameters.

8. The machine for preparing coffee-based beverages as in claim 5, also comprising a command unit configured to command and adjust the functioning of at least one of either said hopper, said grinding member, said hydraulic means or said brewing means, characterized in that wherein said processing unit is configured to transmit said one or more functioning parameters to said command unit in order to control and adjust the functioning of at least one of either said hopper, said grinding member, said hydraulic means or said brewing means.

9. The machine for preparing coffee-based beverages as in claim 1, wherein said one or more actual characteristics comprise at least one characteristic selected from a group comprising the different varieties of said beans, the presence percentage of each of said varieties, the roasting level of said beans and the surface oiliness of said beans.

10. The machine for preparing coffee-based beverages as in claim 1, wherein said one or more functioning parameters comprise at least one parameter selected from a group comprising the temperature of the brewing water, the brewing time, the flow rate of the brewing water, the quantity of brewing water, the brewing pressure, the quantity of coffee-based beverage to be prepared, the pre-brewing parameters comprising the temperature, the quantity of the pre-brewing water, the pre-brewing time, the beverage delivery time, the speed and flow rate of the brewing water, the granulometry and the grinding level of said coffee powder and the quantity of the latter to be subjected to brewing.

11. method for preparing coffee-based beverages starting from coffee beans by means of a machine having a hopper configured to contain said coffee beans, a grinding member associated with said hopper to grind said coffee beans and obtain a coffee powder, brewing means configured to subject said coffee powder to brewing and hydraulic means configured to supply water to said brewing means, wherein said method comprises an identification step in which one or more actual characteristics of said coffee beans are automatically identified by means of identification means, and one or more functioning parameters for at least one of either said grinding member, said brewing means or said hydraulic means are automatically associated with said one or more actual characteristics, characterized in that wherein said identification step provides to acquire at least two images of said beans contained in said hopper, illuminated on each occasion by one of at least two lighting elements configured to emit respective light beams that have different wavelengths from each other, and to process said at least two images in order to identify said one or more actual characteristics.

12. A method for preparing coffee-based beverages as in claim 11, wherein said identification step analyzes at least one of either the shape, sizes or color of said beans represented in said at least two images in order to assign to said beans said one or more actual characteristics, selected from a group comprising the different types and/or the different varieties of said beans, the presence percentage of each of said varieties, the roasting level of said beans and the surface oiliness of said beans.

13. A method for preparing coffee-based beverages as in claim 11, wherein said identification step compares said one or more actual characteristics with one or more combinations of predetermined characteristics, stored in a memory of a processing unit, each of which is associated with a corresponding combination of predetermined functioning parameters stored in said memory of said processing unit, and then associates with said one or more actual characteristics a determinate combination of predetermined functioning parameters corresponding to the combination of predetermined characteristics most similar to said one or more actual characteristics.

14. A method for preparing coffee-based beverages as in claim 11, wherein said identification step assigns determinate numerical values to said one or more actual characteristics and processes said numerical values according to predetermined correlation equations, in order to obtain said one or more functioning parameters.

15. A method for preparing coffee-based beverages as in claim 11, further comprising an adjustment step in which the functioning parameters of said machine are adjusted on the basis of said one or more functioning parameters.
